(19) United States
(12) Patent Application Publication
(10) Pub. No.: US 2013/0050682 A1
(43) Pub. Date: Feb. 28, 2013

(54) YI'S 4-IN-1 ANTIQUE IDENTIFICATION METHOD

(71) Applicant: Weiqian Yi, Xiangtan (CN)

(72) Inventor: Weiqian Yi, Xiangtan (CN)

(73) Assignee: International Art & Antiques Research Association, Inc, Las Vegas, NV (US)

(21) Appl. No.: 13/589,430

(22) Filed: Aug. 20, 2012

Related U.S. Application Data
(60) Provisional application No. 61/490,003, filed on Aug. 22, 2011.

(51) Int. Cl. G01N 9/08; G01N 21/25

(52) U.S. Cl. 356/72

(57) ABSTRACT

The present invention makes Yi's 4-in-1 antique identification method known to the public. It combines visual inspection, colorimetric method, microscopic observation and density comparison to one method. Among them the density comparison is to detect the object's unit weight, contrast the unit weight of object to determine the age. This invention combines the antique's inherent physical constant to confirm its age. The present invention may be used for the identification of porcelain, jade and bronze. The user then obtains more accurate results by using this easy, simple and cost-effective method.

### CROSS-REFERENCE TO RELATED APPLICATIONS

This patent application claims priority from Provisional Patent Application No. 61/490,003 filed Aug. 22, 2012 which is incorporated herein by reference in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to a method for identifying/authenticating antiques. More particularly, the invention relates to identification/authentication of antique porcelain, jade and bronze by using YI'S 4-IN-1 METHOD.

Chinese antiques are prized by museums, art galleries, archaeologists and private collectors all over the world. More and more people buy and collect Chinese antiques not only because of their historical and cultural heritage value, but also economic value. The economic value is increasing significantly, so people greedy for profit have been encouraged to forge copies of old artwork. Forgers employ modern scientific techniques to copy classic antiques, and their ingenious results can often pass for the real thing. This situation creates a need for reliable authentication method to identify forgeries. Therefore, the antique authentication method gets more and more attention from all social classes.

Visual inspection as the traditional identification method, not only requires a vast knowledge but also many years of experience, and sometimes it could be blinded by modern technology, so the collector or appraiser has been challenged on the reliability and accuracy of identification of antiques.

Scientific methods are available but not widely used due to either the relatively high cost involved or incomplete sample data or destruction to the object. For example, Thermoluminescence (TL) dating, used in the authentication of old ceramic wares for the tests of trace of elements and fluorescent analysis, requires the removal of fairly large clay samples of approx. 3 mm diameter, which may destruct thin porcelain; the equipment and technological prowess are not adequate; the instruments cost is relatively high and the operators may not be experienced or skilled at using the new instruments; a broad variety of samples collected from different places and times are required but the data accumulated are often incomplete and sometimes dubious; and forgers always invent new schemes in response to the new tests. Another method, radiocarbon dating, is only used for dating organic materials, but not applicable to inorganic porcelain.

### SUMMARY OF THE INVENTION

The present invention is an antique identification method for users to solve the problems on authenticity, reliability and accuracy of antique identification under a standardized and scientific antique identification method. The antiques include porcelain, jade and bronze.

Because the present invention integrates four methods (steps) in one-visual inspection, colorimetric method, microscopic observation and density comparison, the results are more accurate. The conclusions are likely to be trustworthy since the present invention combines the new scientific tests with traditional methods of authentication.

### BRIEF DESCRIPTION OF THE DRAWING

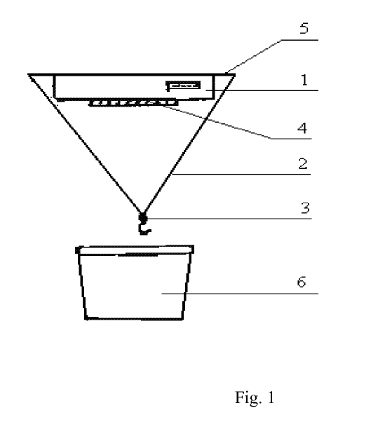

FIG. 1 is a drawing of the step 4 of the present invention;
1. An accurate scale
2. Hanging rope
3. Hook
4. Support plate
5. Support rod
6. Container

The scale (1) is placed on support plate (4), the support rod is placed on the scale (1) and ties the hanging rope (2) at the ends of the support rod (5), and sets the hook (3) for holding the object in the container (6) with water.

### DETAILED DESCRIPTION OF THE INVENTION

Referring now to the invention in more detail:

1. Visual inspection: a traditional identification method, is the first step for dating by not only examining the object's form, texture, composition, glaze color and texture, and ornamentation, but also searching for any kind of inscription, seal or mark.

2. Colorimetric method: to use the color arrangement list of printing, every color is identified according to 10% change in shade, and marked by numbers to establish contrast color code in different periods that compares the identified object with relevant contrast color code.

3. Microscopic observation: to apply the magnifier or microscope on the object's microcosmic features of under glaze structure, bubble formation, rust color, soil penetration and crystallization etc.

4. Density comparison: to detect the density of the object, and compare the density with contrast, then ensure the era of the object.

The method/step 4 describes the measurement of density (E): first, use an accurate scale to weight the object (G); then weight the object again (G1) while it's under steady state in the water; and then calculate the object's density (E, unit: g/cm³) by using the following formula:

$$E = \frac{G}{G - G 1}$$

The advantages of the present invention include, without limitation, that it minimizes the uncertainty of human factors in antique identification which supplies a reliable and standard antique authentication method; that it is cost effective and non-destructive; it uses simple equipment and is easy to operate, so the identification could be done at home.

The foregoing written description of the invention enables any user with ordinary skill to use what is considered presently to be the best method.

It is claimed:

1. The features of Yi's 4-in-1 antique identification method include the following methods/steps:
(1) visual inspection;
(2) colorimetric method;
(3) microscopic observation;
(4) density comparison

2. According to claim 1: method/step (4) describes the measurement of density (E): first, use an accurate scale to weigh the object (G); then weigh the object again (G1) while it's under steady state in the water; and then calculate the object's density (E, unit: g/cm³) by using the following formula:
$$E = \frac{G}{G - G 1}$$

3. According to claim 2: the devices used for the measurement of density include an accurate scale (1), hanging rope (2) and hook (3), the scale (1) is placed on support plate (4), the support rod (5) is placed on the scale (1), and ties the hanging rope (2) at ends of support rod (5), and sets the hook (3) for holding the object in the container (6) which is filled with water.

4. According to any items in claims 1 to 3: the described antique object includes porcelain, jade and bronze.
